(19) United States
(12) Patent Application Publication
(10) Pub. No.: US 2021/0109855 A1
(43) Pub. Date: Apr. 15, 2021

(54) MANAGING GARBAGE COLLECTION FOR A STORAGE SYSTEM

(71) Applicant: Microsoft Technology Licensing, LLC, Redmond, WA (US)

(72) Inventor: Brennan Alexander WATT, San Clemente, CA (US)

(21) Appl. No.: 16/653,219

(22) Filed: Oct. 15, 2019

(51) Int. Cl. G06F 12/02; G06F 9/50

(52) U.S. Cl. CPC G06F 12/0253; G06F 2212/1044; G06F 9/5011

(57) ABSTRACT

The present disclosure relates to systems, methods, and computer readable media for reconfiguring garbage collection configurations and initiating garbage collection in accordance with the reconfigured garbage collection configuration. For example, systems disclosed herein may identify or receive workload data associated with write activity of an application. Systems disclosed herein may additionally reconfigure a garbage collection configuration by modifying storage threshold and corresponding garbage collection parameters associated with initiating and performing garbage collection on a storage system. Based on a comparison of a current state of a storage system and the received workload data, systems disclosed herein may implement an intelligent garbage collection process that reduces media wear and accommodates unique write-based needs for one or more applications.

### BACKGROUND

Recent years have seen a precipitous rise in the use of computing devices (e.g., mobile devices, personal computers, server devices, cloud computing systems) to receive, store, edit, transmit, or otherwise utilize digital data. For example, it is now common for individuals and businesses to store massive quantities of data on local computing devices and/or on remote cloud computing systems. Indeed, as demand for increased storage and memory capacity on computing devices increases, innovations in technology associated with storing and processing data has similarly improved and become more capable.

As storage demand increases for various applications and computing devices (e.g., personal computers, storage servers), storage systems on those computing devices may quickly become outdated and/or run out of available storage resources. In an effort to more effectively utilize limited quantities of storage resources, many conventional systems provide additional storage by writing and re-writing data on a storage device in a more efficient way. For instance, many conventional storage systems implement garbage collection and/or data defragmentation techniques to more efficiently utilize a limited quantity of storage space on a variety of computing devices.

While conventional data management tools (e.g., garbage collection, disk defragmentation) provide effective ways to more efficiently store data on a variety of storage systems (e.g., solid state drive (SSD) devices), conventional techniques for efficiently storing data and freeing up space cause a number of problems and drawbacks. For example, conventional data management tools often cause a significant amount of media wear as a result of performing overly aggressive writing and re-writing of data on the storage system. In addition, conventional data management tools often sacrifice processing performance of the computing device as a result of garbage collection consuming significant processing resources at times that limit performance of one or more host applications.

These and other problems exist with regard to effectively managing data storage on a variety of computing devices.

### BRIEF DESCRIPTION OF THE DRAWINGS

FIG. 1 illustrates an example computing device having a garbage collection management system implemented thereon in accordance with one or more embodiments.

FIG. 2 illustrates an example workflow for reconfiguring a garbage collection configuration in accordance with one or more embodiments.

FIG. 3 illustrates an example series of steps for implementing a reconfigured garbage collection configuration in accordance with one or more embodiments.

FIG. 4 illustrates an example implementation of the garbage collection management system for a burst-style workload in accordance with one or more embodiments.

FIG. 5 illustrates an example series of acts for managing a garbage collection configuration in accordance with one or more embodiments.

FIG. 6 illustrates certain components that may be included within a computer system.

### DETAILED DESCRIPTION

The present disclosure is generally related to managing write bandwidth for a storage system for one or more applications. In particular, the present disclosure includes features and functionality for reconfiguring a garbage collection configuration or otherwise implementing a uniquely tailored storage management contract to more efficiently manage storage of a computing device (e.g., an SSD storage) while providing sufficient write bandwidth for one or more applications (e.g., host applications) on the computing device. For example, where conventional storage systems implement device-specific or pre-configured garbage collection policies, one or more embodiments described herein enable an application to provide workload data indicative of workload requirements and/or historical patterns of storage use to reconfigure a garbage collection configuration in a variety of ways.

For example, as will be discussed in more detail herein, a garbage collection management system can receive or otherwise identify workload data for an application including information associated with write activity of the application with respect to a data storage (e.g., SSD storage) of a computing device. The garbage collection management system may further reconfigure a garbage collection configuration by modifying rules associated with initiating or otherwise conducting garbage collection on the computing device. In accordance with the reconfigured garbage collection configuration (or simply “garbage collection reconfiguration”), the garbage collection management system can initiate garbage collection or other similar data defragmentation process based on a comparison of one or more threshold levels identified or modified by the garbage collection reconfiguration and a current state of storage (e.g., a current level of occupied storage) for the storage system of the computing device.

As will be discussed in further detail below, the present disclosure includes a number of practical applications having features and functionality described herein that provide benefits and/or solve problems associated with performing garbage collection and otherwise managing storage on a computing device. For example, by considering workload data from one or more applications on the computing device, the garbage collection management system may consider unique usage of the storage on the computing device by the application(s) to best consider how to reconfigure a garbage collection configuration (e.g., an initial or default garbage collection configuration). In this way, rather than ensuring an arbitrary amount of free space independent of what applications are operating on the computing device, the garbage collection management system can provide a quantity of free space uniquely suited for application(s) on the computing device resulting in better write performance for a wider range of computing devices.

In addition to achieving better performance generally, the garbage collection management system can provide more accurate performance guarantees to users of the storage system. For example, where conventional systems are generally unable to predict application-specific needs over time for a computing device, applications and/or storage systems are often only able to guarantee a level of performance that the computing device can achieve while performing garbage collection on the computing device. Alternatively, conventional systems may sometimes give inaccurate guarantees based on best-case estimates and simply hope that application writing and garbage collection do not conflict, resulting in dissatisfied customers when the system underperforms as storage utilization approaches capacity for the computing device. Indeed, by intelligently performing garbage collection based on unique workload data, the garbage collection management system can reduce or even avoid periods of time where the computing device underperforms as a result of garbage collection interrupting or otherwise limiting writing bandwidth on the computing device.

In addition to improving write performance on the computing device, features and functionality described herein can further reduce media wear on the storage system. For example, where conventional storage management systems may attempt to ensure high performance by performing garbage collection as frequently as possible using an overly aggressive one-size-fits all garbage collection configuration, the garbage collection management system can consider unique workload data to perform garbage collection less frequently than conventional systems. Indeed, by considering workload data received from or otherwise provided by application(s) on the computing device, the garbage collection management system can significantly reduce a number of writes on the storage system as a result of more intelligently (e.g., less frequently) initiating garbage collection on the computing device.

As illustrated in the foregoing discussion, the present disclosure utilizes a variety of terms to described features and advantages of the systems described herein. Additional detail is now provided regarding the meaning of such terms. For example, as used herein, a “storage system” or “data storage system” may refer to any storage device or collection of storage devices used for storing and providing access to data on a computing device. In one or more implementations described herein, a storage system may include one or more SSD devices, hard disk drive (HDD) devices, NAND storage devices, or any other non-volatile storage that one or more applications may write to and access. In addition, and as will be discussed in further detail below, a storage system may include a storage manager including hardware and/or software for managing storage of data on the storage system.

As used herein, an “application” or “host application” may refer interchangeably to any application capable of writing or causing another application to write data to the storage system. For example, an application may refer to an operating system (OS) of a computing device that interacts with one or more higher level applications on the computing device. In addition, or as an alternative, the application may refer to one or more applications running on the client device capable of accessing and performing write operations (or otherwise causing another application to perform write operations) on the storage system. In one or more implementations, an application refers to a cloud-based application or host application capable of interacting with the client device and/or server node to facilitate writes on a storage system. As will be discussed in further detail below, a computing device may refer interchangeably to a client device (e.g., a mobile or non-mobile client device) or a server device (e.g., a server node on a cloud computing infrastructure).

As mentioned above, the garbage collection management system can manage and modify (e.g., reconfigure) a garbage collection configuration. As used herein, a “garbage collection configuration” or “reconfigured garbage collection configuration” may include any information associated with performing garbage collection on a storage system of a computing device. For example, a garbage collection configuration may include information associated with when to initiate garbage collection as well as a measure of aggressiveness associated with carrying out performance of the garbage collection process. As will be discussed in more detail herein, different aspects of the garbage collection configuration may be reconfigured based on workload data received from or otherwise provided by one or more applications.

As used herein, “workload data” may refer to any information associated with write activity corresponding to one or more applications. For example, workload data may include a record or snapshot of historical write activity performed by one or more applications with respect to a data storage. Workload data may also include a stream of write activity indicating real-time write actions performed by one or more applications. Workload data may additionally include projected or predicted workload data (e.g., based on observed or predicted patterns of write activity). For example, workload data may include an indication of a write demand corresponding to a minimum amount of storage space and/or a desired amount of write data that an application requires or intends to write to a storage system. The workload data may indicate a write demand based on typical or historical behavior of the application and/or based on planned or scheduled write activity that the application will perform with respect to a data storage.

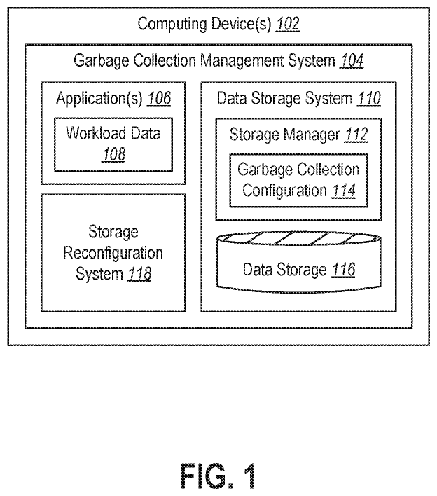

Additional detail will now be provided regarding management of garbage collection for a data storage in relation to illustrative figures portraying example implementations. For example, FIG. 1. Illustrates an example computing device 102 including a garbage collection management system 104 implemented thereon. As shown in FIG. 1, the garbage collection management system 104 includes one or more applications (e.g., application(s) 106) having corresponding workload data 108. The garbage collection management system 104 additionally includes a storage reconfiguration system 118. As further shown, the garbage collection management system 104 includes a data storage system 110 having a storage manager 112 for managing a garbage collection configuration 114. The data storage system 110 additionally includes a data storage 116, which may include one or more storage devices.

The computing device 102 may refer to various types of computing devices. For example, the computing device 102 may refer to a server device, such as a server node or system of nodes on a network of interconnected server devices (e.g., a cloud computing system). In addition, or as an alternative, the computing device 102 may refer to a mobile device such as a mobile telephone, a smart phone, a personal digital assistant (PDA), a tablet, a laptop, or wearable computing device (e.g., a headset or smartwatch). The computing device 102 may further include one or more non-mobile devices such as a desktop computer, a server, or other non-portable device. The computing device 102 may include additional features and functionality described below in connection with FIG. 8.

As shown in FIG. 1, while the garbage collection management system 104 illustrates an application 106 having workload data 108 implemented on the computing device 102, the application(s) 106 may refer to one or multiple different types of applications. For instance, the application(s) 106 may refer to an operating system, one or more higher level applications running on the computing device 102 and/or one or more host applications (e.g., software as a service (SaaS)) operating on a cloud computing device. Moreover, the application(s) 106 may refer to a combination of different types of applications (e.g., operating system, high level applications, host applications) running on one or on multiple devices. Indeed, as indicated above, the application(s) 106 may include one or a combination of any application having access to and/or capable of initiating one or more writes to the data storage 116.

As shown in FIG. 1, the application(s) 106 may include associated workload data 108. As indicated above, the workload data 108 may include any information associated with write activity of the application(s) 106 with respect to the data storage 118. For example, the workload data 108 may include a history of writes performed on the data storage 118 by the application(s) 106. The workload data 108 may further include a real-time stream of write activity data generated by or otherwise provided by the application(s) 106. In one or more implementations, the workload data 108 includes one or more projected workloads. The workload data 108 may additionally include one or more settings, preferences, or requirements associated with logical space on the data storage 118 that the application(s) 106 may need (e.g., write demand) to accommodate a burst of write activity. In one or more embodiments described herein, the workload data 108 may refer to data received from a combination of different applications having access to and capability of writing to a data storage 116 of the computing device 102.

As further shown in FIG. 1, the garbage collection management system 104 includes a data storage system 110 (or simply “storage system 110”), which may include a storage manager 112. The storage manager 112 may include a software or hardware implementation for managing the data storage 116. In particular, the storage manager 112 may monitor storage levels and take a variety of actions to ensure that adequate logical space exists for various applications as well as provide access to application(s) 106 to write to the data storage 116.

In one or more embodiments, and as will be discussed in further detail below, the storage manager 112 may manage garbage collection on the data storage 116 by determining whether to initiate garbage collection. In addition, the storage manager 112 may carry out the garbage collection by identifying blocks of data to rewrite or otherwise defragment in accordance with any number of garbage collection policies included within the garbage collection configuration 114.

As shown in FIG. 1, the storage manager 112 may implement a garbage collection configuration 114 in accordance with one or more embodiments described herein. For example, the garbage collection configuration 114 may include one or more identified storage thresholds to indicate when to initiate garbage collection. In one or more implementations, the garbage collection configuration 114 includes an identification of one or multiple predefined thresholds (e.g., default storage thresholds) corresponding levels of storage space associated with initiating a garbage collection process. In one or more implementations, the garbage collection configuration 114 includes or otherwise introduces a storage space ratio contract that governs when and how garbage collection may be initiated and carried out on the storage system 110.

In addition, the garbage collection configuration 114 may include settings, policies, and various rules to govern how the garbage collection is performed. For example, the garbage collection configuration 114 may include policies associated with how often or how aggressive the storage manager 112 will be in beginning or carrying out a garbage collection process. For instance, the garbage collection configuration 114 may include rules indicating a measure of fragmentation that should exist for one or more blocks of storage space prior to initiating garbage collection. In addition, the garbage collection configuration 114 may identify an allocation of processing bandwidth to allocate between the storage manager 112 and/or application(s) 106 to facilitate garbage collection while maintaining a threshold level of performance for the application(s) 106.

As further shown in FIG. 1, the garbage collection management system 104 includes a storage reconfiguration system 118 capable of reconfiguring a garbage collection configuration 114 based on workload data 116. While FIG. 1 illustrates an example in which the storage reconfiguration system 118 is implemented independent of the application(s) 106 and data storage system 110, in one or more implementations, the storage reconfiguration system 118 is implemented on an application (e.g., a host application, operating system, or other application capable of writing to the data storage 116) or, alternatively, on the storage system 110. Accordingly, while one or more embodiments described herein describe the storage reconfiguration system 118 independent from the application(s) 106 and/or data storage system 110, one or more features described herein in connection with the storage reconfiguration system 118 and associated with modifying one or more parameters or policies of the garbage collection configuration 114 may be implemented on the storage system 110 (e.g., as a sub-component of the storage system 110 or the storage manager 112) and/or on the application(s) 106 (e.g., as part of an operating system or a host application).

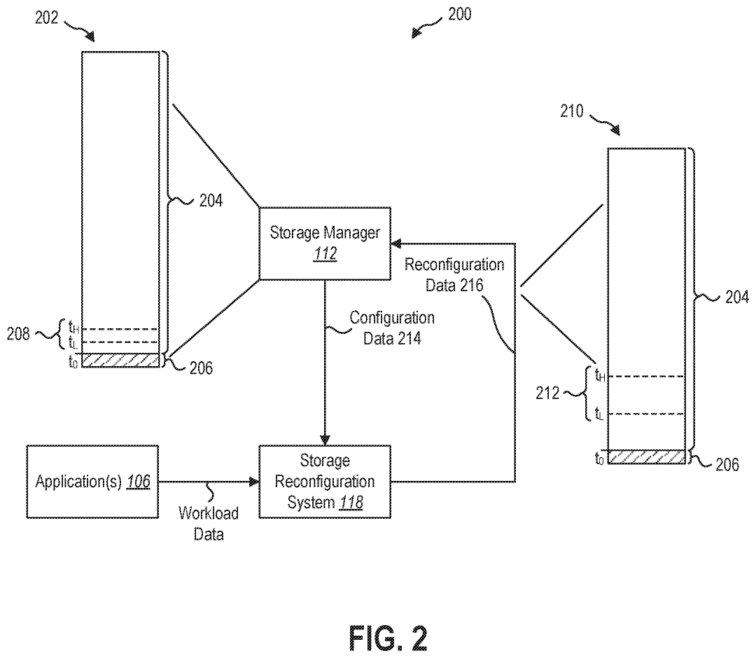

As will be discussed in further detail below, the storage reconfiguration system 118 can reconfigure or otherwise modify the garbage collection configuration 114 based the workload data 108. In particular, the storage reconfiguration system 118 can modify any of one or more parameters of the garbage collection configuration 116 to modify when and/or how a garbage collection process is managed for the data storage 116. For example, the storage reconfiguration system 118 can modify one or more parameters associated with how the garbage collection is carried out (e.g., processing bandwidth and/or fragmentation parameters). In addition, and as will be discussed in further detail below in connection with FIG. 2, the storage reconfiguration system 118 can modify one or more storage thresholds associated with when a garbage collection process is initiated.

It will be understood that FIG. 1 illustrates an example diagram of the garbage collection management system 104 in which components 106-118 are implemented on a computing device. It will be appreciated that components 106-118 of the garbage collection management system 104 may be implemented across one or multiple computing devices. As an example, the garbage collection management system 104 may be implemented across multiple server devices of a cloud computing system. As another example, the application(s) 106 may be implemented on a server device while other components 110-118 are implemented on a client device.

In one or more embodiments, each of the components 106-118 of the garbage collection management system 104 are in communication with one another using any suitable communication technologies. Additionally, the components 106-118 of the garbage collection memory system 104 may be in communication with other devices. It will be understood that while the components 106-118 of the garbage collection memory system 104 shown in FIG. 1 are shown to be separate in FIG. 1, any of the subcomponents may be combined into fewer components, such as into a single component, or divided into more components as may serve a particular embodiment.

The components 106-118 of the garbage collection memory system 104 may include software, hardware, or both. For example, the components 106-118 of the garbage collection memory system 104 may include one or more instructions stored on a computer-readable storage medium and be executable by processors of one or more computing devices. When executed by the one or more processors, the computer-executable instructions of the garbage collection memory system 104 can perform one or more methods described herein. Alternatively, the components 106-118 of the garbage collection memory system 104 can include hardware, such as a special-purpose processing device to perform a certain function or group of functions. Additionally, or alternatively, the components 106-118 of the garbage collection memory system 104 can include a combination of computer-executable instructions and hardware.

An example implementation of the garbage collection memory system 104 for reconfiguring a garbage collection configuration is now described in connection with an example framework illustrated in FIG. 2. For example, as shown in FIG. 2, one or more application(s) 106 may provide workload data (e.g., workload data 108) to a storage reconfiguration system 118. The workload data may include an identification of writes to a data storage 116 and any additional information about the respective writes. For example, the workload data may include an indicated number of writes, timestamps associated with the writes, and sizes and/or locations of storage blocks affected by the identified writes. In addition, the workload data may include requirements or preferences to accommodate upcoming bursts of writing to the data storage 116.

As further shown, the storage reconfiguration system 118 can receive configuration data 214 from the storage manager 112. In particular, the storage reconfiguration system 118 can receive a garbage collection configuration 114 including any information associated with when to initiate a garbage collection process as well as parameters for carrying out the garbage collection process. In addition to configuration data 214, the storage manager 112 may provide telemetry data to the storage reconfiguration system 118 so that the reconfiguration system 118 is aware of how much space has been cleared for writing. This enables the storage reconfiguration system 118 to have access to a current state of storage on the storage system 110 in addition to the garbage collection configuration 114 including parameters and settings associated with garbage collection is performed.

To illustrate features of the configuration data 214 provided to the storage reconfiguration system 118, FIG. 2 shows a first visualization 202 of a garbage collection configuration (e.g., a default or initiate garbage collection configuration). As shown in FIG. 2, the first visualization 202 shows a logical space portion 204 representative of writable space on a data storage 116. As further shown, the first visualization 202 shows an overprovisioned portion 206 representative of an amount of storage space on the data storage 116 that needs to remain unallocated in order for the storage system 110 to operate at a minimum level of performance. By way of example and not limitation, where a data storage represented by the first visualization 202 has one terabyte (TB) of SSD storage, the logical space portion 204 may include 960 gigabytes (GB) while the overprovisioned portion 206 includes 40 GB.

As further shown in FIG. 2, the first visualization 202 shows a plurality of storage thresholds 208 corresponding to different ratios of available and allocated storage space on the data storage 116. For example, the storage thresholds 208 include a high threshold (t_{H}) corresponding to a first ratio of available and allocated storage space on the data storage 116. In addition, the storage thresholds 208 include a low threshold (t_{H}) corresponding to a second ratio of available and allocated storage space on the data storage 116. Other embodiments may include fewer (e.g. 1) or additional thresholds (e.g., greater than 2). As further shown, the first visualization 202 shows a critical or minimum threshold (t₀) corresponding to a ratio between the logical space portion 204 and the overprovisioned portion 206.

As used herein, “available storage space” refers to any portion or block of the data storage 116 that is blank or otherwise capable of storing data written to the data storage 116. As used herein, “allocated space” or “occupied space” refers to any portion or block of space on the data storage 116 that has data stored thereon or is not available to receive additional data stored thereon. The allocated space may include fragmented data including a first portion of current data (e.g., data to keep) and a second portion of outdated or otherwise useless data (e.g., data to discard). More specifically, when performing a garbage collection process on a block of fragmented data, the storage manager 112 may keep a first portion of data by writing the first portion to a block of available storage space while discarding the second portion of data previously stored on the fragmented portion of allocated space on the data storage 116.

It will be understood that the positions of the storage thresholds 208 as well as the positions of the logical space portion 204 and overprovisioned portion 206 are not necessarily at fixed positions on the data storage 116. For example, in performing garbage collection, the overprovisioned portion 206 may be used to defragment a previously fragmented portion of data. In addition, fragmented portion of data may be discarded and become a new overprovisioned portion of the data storage 116. Thus, the overallocated portion 206 may change positions on the data storage 116 relative to the logical space portion 204 as garbage collection is performed. The movable nature of the overprovisioned portion 206, which may be applicable to various storage types, may further reduce media wear on the data storage system 116.

As shown in FIG. 2, based on the received workload data and configuration data 214, the storage reconfiguration system 118 can generate reconfiguration data 216 including a one or more modified storage thresholds. In particular, the storage reconfiguration system 118 can reconfigure the garbage collection configuration 114 based on received workload data by modifying storage thresholds. To illustrate, FIG. 2 shows a second visualization 210 of a reconfigured garbage collection configuration including the logical space portion 204 and the overallocated portion 206. The second visualization 210 further includes a modified plurality of thresholds 212 including a modified high threshold (t_{H}) and a modified low threshold (t_{L}) corresponding to modified ratios of available and allocated storage space on the data storage 116. The second visualization 210 additionally shows a critical or minimum threshold (t₀) corresponding to a ratio between the logical space portion 204 and the overprovisioned portion 206.

As further shown, the storage reconfiguration system 118 can provide the reconfiguration data 216 to the manager 112 for reconfiguring the garbage collection configuration 114 in accordance with one or more embodiments described herein. For example, the storage reconfiguration system 118 can provide modified thresholds to the storage manager 112 to modify previously determine threshold (e.g., the default storage thresholds) as well as reconfigure any parameters associated with when or how to perform garbage collection on the data storage 116.

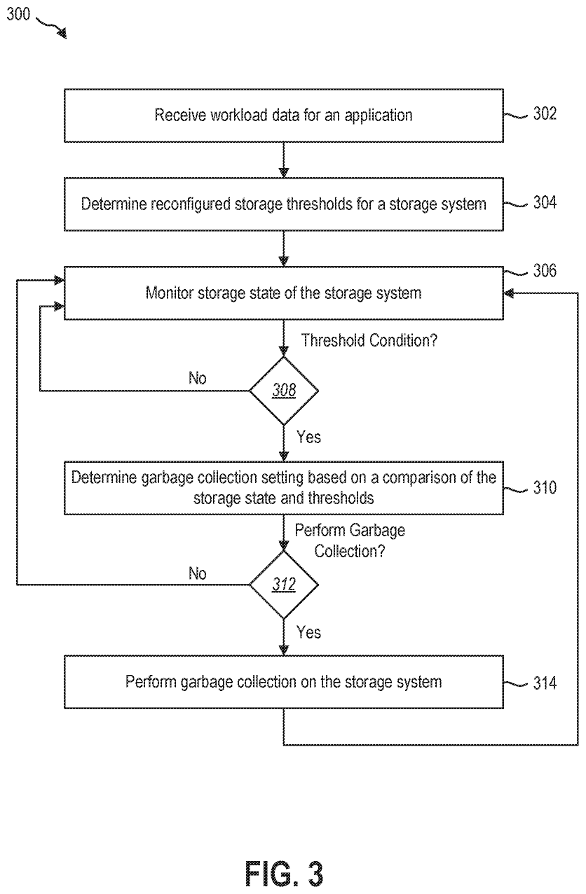

In one or more embodiments, the garbage collection management system 104 reconfigures the garbage collection configuration 114 by simply applying existing garbage collection policies based on the modified thresholds in accordance with the reconfiguration data 216. For example, based on the modified storage thresholds 212, the storage manager 112 may initiate garbage collection upon determining that a current state of the data storage 116 has less available storage space than the modified high threshold (t_{H}) and/or the modified low threshold (t_{H}). In addition, the garbage collection management system 104 may implement different policies depending on whether the current state of the data storage 116 is between the high storage threshold (t_{H}) and the low storage threshold (t_{L}) or below both the high storage threshold (t_{H}) and the low storage threshold (t_{L}). Indeed, where the garbage collection configuration 114 includes additional storage thresholds, the storage manager 112 may implement different garbage collection policies based on a current state of the data storage 116 (e.g., a current state of available storage space) relative to each of the storage thresholds. Additional information in connection with initiating and performing garbage collection based on a comparison of a current storage state and one or more storage thresholds is discussed below in connection with FIG. 3.

In addition to modifying thresholds or otherwise modifying parameters and policies of a garbage collection configuration, the storage reconfiguration system 118 may facilitate strategic timing of performing writes (e.g., burst writes) to the data storage 116. For example, where the storage reconfiguration system 118 receives telemetry data associated with a current state of storage on the storage system 110, the storage reconfiguration system 118 may utilize this information to enable the application(s) 106 to be aware of when necessary storage space is cleared. Thus, in addition to modifying a schedule of when garbage collection is initiated and how garbage collection is performed, the storage reconfiguration system 118 may additionally influence timing of when the application(s) 106 write to the storage system 110.

FIG. 3 illustrates an example series of acts 300 for reconfiguring a garbage collection configuration 116 as well as initiating and performing a garbage collection process in accordance with the reconfigured garbage collection configuration. Each of the acts of the series of acts 300 may be performed by one or more of the components of the garbage collection management system 104.

As shown in FIG. 3, the series of acts 300 includes an act 302 of receiving workload data for an application. As mentioned above, the workload data may include tracked write activity by the application(s) 106 with respect to the data storage 116. In addition, in one or more embodiments, the workload data includes identified trends or patterns of write activity over time based on tracked writes to the data storage 116. For example, the storage reconfiguration system 118 may identify variable trends of write activity (e.g., bursts of activity followed by periods of inactivity) and determine patterns over time associated with write activity of the application(s) 106 in connection with the data storage 116. The workload data 108 may further include information about demands or preferences of the application(s) 106 associated with how much space is needed to perform writes (e.g., burst writes) on the data storage 116.

As further shown in FIG. 3, the series of acts 300 includes an act 304 of determining reconfigured storage thresholds for a storage system (e.g., the data storage system 110). For example, the garbage collection management system 104 can determine one or more modified thresholds corresponding to different ratios of available storage and allocated storage on the storage data storage 116. For example, where the application(s) 106 has workload data that indicates a history of writing large files or a burst-style workload (e.g., brief periods of high write activity), the garbage collection management system 104 may increase one or more thresholds to have a lower ratio between allocated space and available space at each of the one or more storage thresholds. Modifying the thresholds to this ratio may ensure a higher level of performance of the computing device 102 during periods where the application(s) 106 performs one or more bursts of writing activity to the data storage 116.

Alternatively, where the application(s) 106 has a more steady workload and/or where the workload data indicates more frequent writes or writes of smaller data files, the garbage collection management system 104 may decrease one or more thresholds to have a higher ratio between allocated space and available space at each of the one or more storage thresholds. Modifying the thresholds to ratios in this way may reduce media wear as a result of performing garbage collection less frequently. In addition, the garbage collection management system 104 may still ensure high performance as the application(s) 106 may perform a limited number of writes to the storage device 106 while performing limited garbage collection processes.

As further shown, the series of acts 300 may include an act 306 of monitoring a storage state of the storage system 110 (e.g., of the data storage 116 on the storage system 110). For example, the garbage collection management system 104 can monitor write activity on the data storage 116 to determine a current state of availability to write on the data storage 116. In one or more embodiments, the garbage collection management system 104 monitors a current state of the data storage 116 by monitoring a ratio between allocated space and available space on the data storage 116. In one or more embodiments, the storage system 110 advertises or otherwise provides telemetry data to inform the storage reconfiguration system 118 and/or application(s) 106 of a current state of storage on the data storage 116.

As shown in FIG. 3, the garbage collection management system 104 may additional perform an act 308 of determining whether a threshold condition exists. In particular, the garbage collection management system 104 can compare one or more thresholds (e.g., the modified thresholds from the reconfigured garbage collection configuration) to the current state of the data storage 116 to determine whether one or more threshold conditions apply. In one or more embodiments, the garbage collection management system 104 compares the threshold(s) to the current state by determining whether a current state of available data is less than one or more storage thresholds (e.g., a high threshold (t_{H}) and/or a low threshold (t_{L})). As shown in FIG. 3, where the threshold condition does not apply, the garbage collection management system 104 may continue performing act 306.

Alternatively, where one or more threshold conditions apply, the garbage collection management system 104 can perform an act 310 of determining a garbage collection setting based on a comparison of the storage state and the threshold(s). For example, based on a current state of available storage data relative to the storage threshold(s), the garbage collection management system 104 can identify a corresponding garbage collection setting to implement based on the workload data. For instance, in accordance with one or more embodiments described herein, the reconfigured garbage collection configuration 114 may include a plurality of different sets of garbage collection parameters that determine a measure of aggressiveness for initiating or otherwise performing garbage collection based on a current state of available space on the data storage 116 relative to the reconfigured storage thresholds.

For example, where a current state (e.g., an amount of available storage space) is below a high threshold (t_{H}) and above a low threshold (t_{L}), the garbage collection management system 104 may apply a garbage collection policy with a rule to initiate garbage collection only if a measure of write activity is below a threshold amount. Thus, the garbage collection management system 104 may implement a garbage collection policy having a low measure of aggressiveness to avoid potentially interfering with performance of the application(s) 106 writing data to the remaining available space of the data storage 116.

As another example, where a current state is below the high threshold (t_{H}) and the low threshold (t_{L}) (e.g., indicating a lower amount of available storage space than the previous example), the garbage collection management system 104 may apply a garbage collection policy with a rule to initiate garbage collection independent of a current state of write activity (e.g., even if the write activity is above a threshold amount). Thus, the garbage collection management system 104 may implement a garbage collection policy having a high measure of aggressiveness to avoid more catastrophic storage failures as a result of running out of available data on the data storage 116.

In addition to identify settings associated with initiating garbage collection under different storage conditions, the garbage collection management system 104 can additionally initiate or otherwise perform garbage collection at varying degrees of aggressiveness. For example, where the current state is below a high threshold (t_{H}) and above a low threshold (t_{L}), the garbage collection management system 104 may identify a garbage collection parameter that identifies a threshold fragmentation of a block of data that the block of data should exceed before performing garbage collection on that particular block of data. Thus, the garbage collection management system 104 may implement a less aggressive policy by waiting to perform garbage collection on a specific block of data until the garbage collection may be done in a more efficient way that does not expend considerable processing resources to only free up a relatively low amount of storage space.

As another example, where a current state is below the high threshold (t_{H}) and the low threshold (t_{L}), the garbage collection management system 104 may implement a more aggressive fragmentation policy in which the garbage collection management system 104 performs garbage collection on a block of data independent of a measure of fragmentation (or simply identifies a block of data having a higher degree of fragmentation than other blocks of data). Thus, the garbage collection management system 104 may implement a more aggressive policy by performing garbage collection on a specific block of data even where performing fragmentation only frees up a small amount of space (e.g., relative to other less aggressive garbage collection policies).

In one or more embodiments, the garbage collection management system 104 considers a more aggressive garbage collection policy that identifies larger blocks of data to defragment based on a current state of available storage space relative to the modified storage thresholds. For example, a current state of the data storage 116 corresponding to a first threshold may correspond to a garbage collection policy associated with identifying larger blocks of space to defragment than a state of the data storage 116 corresponding to a second threshold.

Upon identifying a corresponding garbage collection setting or policy based on the storage state, the garbage collection management system 104 can perform an act 312 of determining whether to perform garbage collection. In particular, the garbage collection management system 104 may determine if the garbage collection setting indicates that garbage collection should be initiated (and/or how it should be performed) or, alternatively, if the garbage collection setting indicates that garbage collection should not be initiated. Where the garbage collection management system 104 determines not to perform garbage collection, the garbage collection management system 104 can continue performing act 306 of monitoring the storage state of the storage system (e.g., to determine whether a garbage collection trigger becomes applicable).

Alternatively, where the garbage collection management system 104 determines to perform garbage collection, the garbage collection management system 104 can perform an act 314 of performing garbage collection on the storage system 110. In particular, the garbage collection management system 104 can perform garbage collection on one or more blocks of storage data in accordance with the identified garbage collection setting based on the comparison of the workload data and the applicable storage threshold(s) from the reconfigured garbage collection configuration. As shown in FIG. 3, after performing garbage collection, the garbage collection management system 104 can return to performing act 306 until determining that one or more thresholds and/or garbage collection settings become applicable.

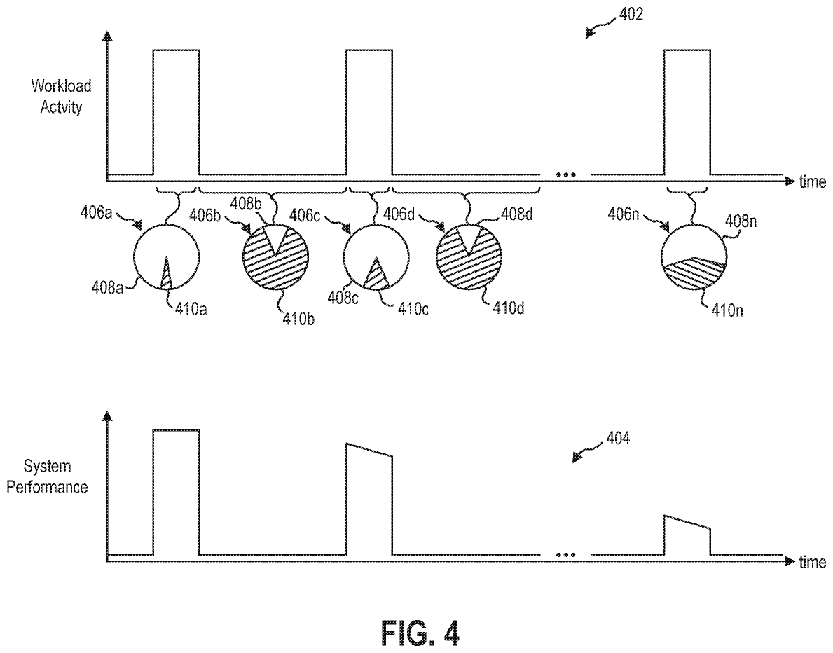

FIG. 4 illustrates an example implementation of the garbage collection management system 104 based on an example workload for an application (e.g., application(s) 106) on a computing device (e.g., computing device(s) 102). In particular, FIG. 4 illustrates workflow activity graph 402 and a corresponding system performance graph 404 as a result of reconfiguring a garbage collection configuration and performing garbage collection in accordance with one or more embodiments described herein. The workflow activity graph 402 is an example of workflow activity that may be received from the application(s) 106 and/or storage system 110. Alternatively, the workflow activity graph 402 is an example of a workflow graph generated by the storage reconfiguration system 118 based on tracked write activity in connection with write actions performed on the data storage 116 by the application(s) 106. In one or more embodiments, the workflow activity graph 402 refers to an observed and/or predicted workflow for an application over time.

As shown in FIG. 4, the workflow activity for the corresponding application(s) is a burst-style workload that includes peaks of activity followed by periods of inactivity. For instance, FIG. 4 shows an activity reflective of many client devices that have burst-style workloads and/or virtual machines on server devices having burst-style workloads. Thus, if garbage collection were to be initiated during the periods of peak activity on devices/machines having a burst-style workload, it would have a significant impact on performance of the computing device. In addition, where garbage collection is performed during periods of low or non-existent workloads, the garbage collection management system 104 can perform garbage collection while having a minimal impact on the system performance.

FIG. 4 additionally illustrates further functionality of the storage reconfiguration system 118 in connection with allocating processing bandwidth between garbage collection and application writes. In particular, in addition to modifying storage thresholds and how the garbage collection process is performed, the garbage collection management system 104 may further facilitate an application-aware allocation of processing bandwidth between application writes and garbage collection. In particular, by considering workload data 108 provided by the application(s) 108 as well as considering telemetry data provided by the data storage system 110, the storage reconfiguration system 118 can additionally schedule or more intelligently allocate processing bandwidth, as shown in FIG. 4.

For example, FIG. 4 shows bandwidth allocation graphs 406a-n corresponding to different periods of time as determined by the storage reconfiguration system 118. In particular, each of the bandwidth allocation graphs 406a-n show an allocation of application processing resources 408a-n and garbage collection processing resources 410a-n corresponding to the different periods of time. As shown in FIG. 4, the specific bandwidth allocation may be different at different times in accordance with a reconfigured garbage collection configuration and based on trends of workload data in accordance with one or more embodiments described herein.

For example, during a first peak period, the garbage collection management system 104 may implement a garbage collection configuration based on a current state of a data storage at a time leading up to the peak performance period and/or during the peak performance period. In this example, the garbage collection management system 104 may apply processing resources in accordance with the first bandwidth allocation graph 406a in which the vast majority of processing resources are allocated to one or more applications while minimal processing resources are allocated to garbage collection.

Alternatively, during a first period of inactivity in accordance with a reconfigured garbage collection configuration and based on write activity predicting or otherwise indicating the period of inactivity (e.g., an absence of write activity by the application(s) 106), the garbage collection management system 104 may allocate processing resources in accordance with the second bandwidth allocation graph 406b in which the vast majority of processing resources are allocated to garbage collection while minimal processing resources are allocated to the one or more applications. Indeed, based on an observed or predicted period of inactivity (e.g., determined based on the workload data from the application(s)) and in accordance with the reconfigured garbage collection configuration, the garbage collection management system may initiate or perform garbage collection to create additional free space on the data storage 116.

In one or more embodiments, the garbage collection management system 104 determines a measure of aggressiveness for performing the garbage collection based on a predicted period of time (e.g., a length of time) that the application(s) is not expected to write to the data storage 116. Moreover, the garbage collection management system 104 may determine a measure of aggressiveness for performing the garbage collection based on a comparison between a current state of storage and an applicable one or more storage thresholds, as discussed above.

As shown in FIG. 4, the garbage collection management system 104 may similarly allocate processing bandwidth during a second peak period. In particular, as shown in FIG. 4, during a second peak period, the garbage collection management system 104 may implement garbage collection configuration based on a state of data storage at a time leading up to the second peak performance period. In addition, as shown in FIG. 4, the garbage collection management system 104 may allocate processing bandwidth in accordance with a third bandwidth allocation graph 406c.

As shown in FIG. 4, the third bandwidth allocation graph 406a may include a different distribution of the application processing bandwidth 408c and the garbage collection processing bandwidth 410c than the distribution of the application processing bandwidth 408a and the garbage collection processing bandwidth 410a from the first bandwidth allocation graph 406a. This may be in accordance with a reconfigured garbage collection configuration reflective of less available space on the data storage 116 during the time period of the second peak activity than during the time period of the first peak activity.

As further shown, during a second period of inactivity and in accordance with a reconfigured garbage collection configuration and based on write activity data predicting or otherwise indicating the period of inactivity, the garbage collection management system 104 may allocate processing resources in accordance with the fourth bandwidth allocation graph 406d. As shown in FIG. 4, the fourth bandwidth allocation graph 406d may include a similar distribution of processing resources as the second bandwidth allocation graph 406b.

Over time, the distribution of processing bandwidth may approach an equilibrium allocation of processing resources. For example, during an nth peak period corresponding to a later time period, the garbage collection management system 104 may allocate processing bandwidth in accordance with an nth allocation graph 408n. As a result of limited storage space (e.g., as storage space becomes more limited), the garbage collection management system 104 may allocate a larger portion of processing bandwidth to garbage collection relative to the application(s).

As mentioned above, FIG. 4 additionally shows a performance graph 404 showing levels of write performance over time. For example, during the first peak period and because sufficient storage space is available on a data storage 116, the system performance may be at a peak performance metric. As storage space becomes more limited, however, and as the garbage collection configuration is reconfigured in accordance with workload data and the current state of storage falling below different thresholds, the overall performance of the data storage system 110 may decrease over time.

Nevertheless, as shown in FIG. 4, the garbage collection management system 104 may ensure high performances over longer periods of time than conventional systems, particularly at the beginning of burst writing periods as a result of aggressively performing garbage collection during periods of inactivity (e.g., based on workload data unique to the application(s)). Thus, where conventional storage systems may simply see an overall decline as storage space becomes more limited, as well as occasionally seeing sharp decline during peak periods if the garbage collection engages, one or more embodiments described herein may see a number of benefits over conventional systems in the way of system performance.

In particular, because the garbage collection management system 104 selectively engages garbage collection during periods of inactivity based on received workload data (and storage telemetry data), the garbage collection management system 104 can ensure that periods in which an application is performing burst rights (e.g., the peak activity periods) are not interrupted by untimely initiating garbage collection and allocating a majority of processing resources to the garbage collection process. Moreover, even where conventional systems may coincidentally avoid performing garbage collection during peak write times, the garbage collection management system 104 may nonetheless achieve higher system performance during the peak write times, particular when burst writing is first initiated, as shown in FIG. 4.

It will be understood that FIG. 4 illustrates an example workload and corresponding performance based on applications having a burst-style workload. Similar features and characteristics may apply to a wide variety of workload styles. Indeed, features and functionality of the garbage collection management system 104 may be implemented in connection with workload data having any variable write activity to accomplish similar benefits as discussed herein in connection with a burst-style workload as shown in FIG. 4.

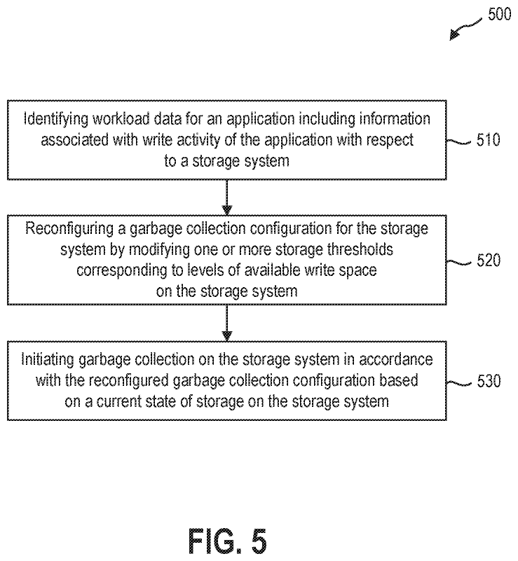

Turning now to FIG. 5, this figure illustrates example flowcharts including series of acts for reconfiguring a garbage collection configuration and implementing garbage collection in accordance with one or more embodiments described herein. While FIG. 5 illustrates acts according to one or more embodiments, alternative embodiments may omit, add to, reorder, and/or modify any of the acts shown in FIG. 5. The acts of FIG. 5 can be performed as part of a method. Alternatively, a non-transitory computer-readable medium can include instructions that, when executed by one or more processors, cause a computing device to perform the acts of FIG. 5. In still further embodiments, a system can perform the acts of FIG. 5.

As shown in FIG. 5, a series of acts 500 may include an act 510 of identifying workload data for an application including information associated with write activity of the application with respect to a storage system. For example, the act 510 may include identifying workload data for one or more applications, the workload data including information associated with write activity of the one or more applications with respect to a storage system on a computing device. In one or more embodiments. In one or more embodiments, the storage system includes one or more solid state drive (SSD) storage devices from a local storage of a client device having the one or more applications running thereon. In addition, or as an alternative, in one or more implementations, the storage system includes storage of one or more server devices on a cloud computing system where the workload data indicates a level of writes to storage shared by a plurality of tenants of the cloud computing system.

As further shown in FIG. 5, the series of acts 500 may include an act 520 of reconfiguring a garbage collection configuration for the storage system by modifying one or more storage thresholds corresponding to levels of available write space on the storage system. For example, the act 520 may include reconfiguring a garbage collection configuration for the storage system based on the workload data by modifying one or more storage thresholds corresponding to levels of available storage space on the storage system where the one or more storage thresholds are associated with initiating garbage collection on the storage system.

In one or more embodiments, the workload data for the one or more applications indicates a level of write demand for writing data to the storage system. In this example, reconfiguring the garbage collection configuration may include modifying the one or more thresholds based on the indicated level of write demand for writing data to the storage system.

The series of acts 500 may additionally include an act 530 of initiating garbage collection on the storage system in accordance with the reconfigured garbage collection configuration based on a current state of storage on the storage system. For example, the act 530 may include initiating garbage collection on the storage system in accordance with the reconfigured garbage collection configuration based on a comparison of the modified one or more storage thresholds and a current state of storage on the storage system. In one or more implementations, initiating garbage collection includes identifying a block of storage on the storage system based on a current level of fragmentation of the block of storage, the block of storage including a first portion of data to keep (and a second portion of data to discard) and writing the first portion of data from the block of storage to a free block of data on the storage system.

In one or more implementations, reconfiguring the garbage collection configuration further includes allocating additional processing resources for performing garbage collection based on one or more periods of time that write activity is predicted to be below a threshold rate. In this example, the act of initiating garbage collection may include initiating garbage collection during the one or more predicted periods of time that write activity will be below the threshold rate.

In one or more embodiments, the series of acts 500 further includes identifying, from the reconfigured garbage collection configuration, an allocation of processing resources between performing garbage collection on the storage system and performing write operations on the storage system by the one or more applications based on the comparison of the modified one or more storage thresholds and the current state of storage on the storage system. In this example, initiating garbage collection may include allocating processing resources for garbage collection and performing write operations in accordance with the identified allocation of processing resources from the reconfigured garbage collection configuration.

In one or more embodiments, the one or more storage thresholds include a first storage threshold associated with a first level of aggressiveness for initiating garbage collection on the storage system and a second storage threshold associated with a second level of aggressiveness for initiating garbage collection on the storage system where the first storage threshold is associated with a higher quantity of available storage space on the storage system than the second storage threshold. The first storage threshold and the second storage threshold may include modified storage thresholds from a default garbage collection configuration including a first default storage threshold and a second default storage threshold.

In one or more embodiments, the series of acts 500 includes determining that the current state of storage on the storage system is between the first storage threshold and the second storage threshold. Further, the series of acts 500 may include initiating garbage collection on the storage system based on the current state of storage on the storage system being between the first storage threshold and the second storage threshold and further based on the workload data indicating that a current level of write activity is below a threshold rate.

In one or more embodiments, the series of acts 500 includes determining that the current state of storage on the storage system is below both the first storage threshold and the second storage threshold. Further, the series of acts 500 may include initiating garbage collection on the storage system based on the current state of storage on the storage system being below both the first storage threshold and the second storage threshold and independent of the workload data indicating a current level of write activity being above a threshold rate.

In one or more embodiments, the application refers to an application on the computing device (e.g., an operating system or high level application). In addition, the workload data may include information associated with write activity of the application with respect to an SSD storage on the computing device.

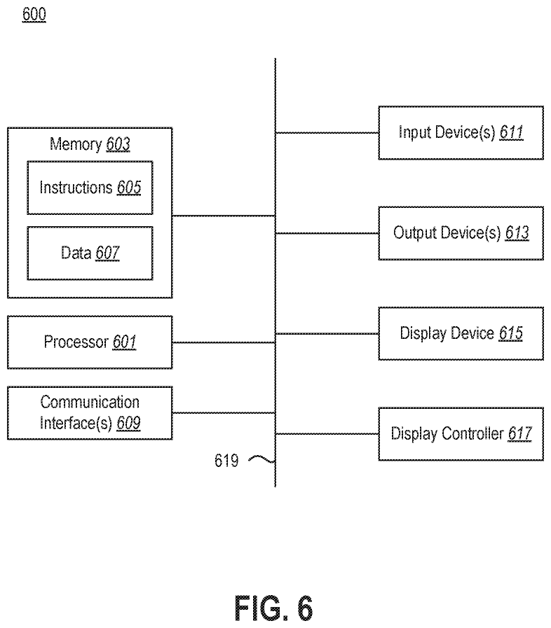

FIG. 6 illustrates certain components that may be included within a computer system 600. One or more computer systems 600 may be used to implement the various devices, components, and systems described herein.

The computer system 600 includes a processor 601. The processor 601 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
identifying workload data for one or more applications, the workload data including information associated with write activity of the one or more applications with respect to a storage system on a computing device;
reconfiguring a garbage collection configuration for the storage system based on the workload data by modifying one or more storage thresholds corresponding to levels of available storage space on the storage system, the one or more storage thresholds being associated with initiating garbage collection on the storage system; and
initiating garbage collection on the storage system in accordance with the reconfigured garbage collection configuration based on a comparison of the modified one or more storage thresholds and a current state of storage on the storage system.

2. The method of claim 1, wherein initiating garbage collection comprises:
identifying a block of storage on the storage system based on a current level of fragmentation of the block of storage, the block of storage including a first portion of data to keep; and
writing the first portion of data from the block of storage to a free block of data on the storage system.

3. The method of claim 1, wherein reconfiguring the garbage collection configuration further includes allocating additional processing resources for performing garbage collection based on one or more periods of time that write activity is predicted to be below a threshold rate.

4. The method of claim 3, wherein initiating garbage collection comprises initiating garbage collection during the one or more predicted periods of time that write activity will be below the threshold rate.

5. The method of claim 1,
wherein the workload data for the one or more applications indicates a level of write demand for writing data to the storage system, and
wherein reconfiguring the garbage collection configuration for the storage system comprises modifying the one or more thresholds based on the indicated level of write demand for writing data to the storage system.

6. The method of claim 1, further comprising:
identifying, from the reconfigured garbage collection configuration, an allocation of processing resources between performing garbage collection on the storage system and performing write operations on the storage system by the one or more applications based on the comparison of the modified one or more storage thresholds and the current state of storage on the storage system, and
wherein initiating garbage collection comprises allocating processing resources for garbage collection and performing write operations in accordance with the identified allocation of processing resources from the reconfigured garbage collection configuration.

7. The method of claim 1, wherein the one or more storage thresholds include a first storage threshold associated with a first level of aggressiveness for initiating garbage collection on the storage system and a second storage threshold associated with a second level of aggressiveness for initiating garbage collection on the storage system, wherein the first storage threshold is associated with a higher quantity of available storage space on the storage system than the second storage threshold.

8. The method of claim 7, wherein the first storage threshold and the second storage threshold comprise modified storage thresholds from a default garbage collection configuration including a first default storage threshold and a second default storage threshold.

9. The method of claim 7, further comprising:
determining that the current state of storage on the storage system is between the first storage threshold and the second storage threshold; and
initiating garbage collection on the storage system based on the current state of storage on the storage system being between the first storage threshold and the second storage threshold and further based on the workload data indicating that a current level of write activity is below a threshold rate.

10. The method of claim 7, further comprising:
determining that the current state of storage on the storage system is below both the first storage threshold and the second storage threshold; and
initiating garbage collection on the storage system based on the current state of storage on the storage system being below both the first storage threshold and the second storage threshold and independent of the workload data indicating a current level of write activity being above a threshold rate.

11. The method of claim 1, wherein the storage system includes one or more solid state drive (SSD) storage devices from a local storage of a client device having the one or more applications running thereon.

12. The method of claim 1, wherein the storage system includes storage of one or more server devices on a cloud computing system, and wherein the workload data indicates a level of writes to storage shared by a plurality of tenants of the cloud computing system.

13. A system, comprising:
one or more processors;
memory in electronic communication with the one or more processor; and
instructions stored in the memory, the instructions being executable by the one or more processors to:
identify workload data for one or more applications, the workload data including information associated with write activity of the one or more applications with respect to a storage system on a computing device;
reconfigure a garbage collection configuration for the storage system based on the workload data by modifying one or more storage thresholds corresponding to levels of available storage space on the storage system, the one or more storage thresholds being associated with initiating garbage collection on the storage system;
initiate garbage collection on the storage system in accordance with the reconfigured garbage collection configuration based on a comparison of the modified one or more storage thresholds and a current state of storage on the storage system.

14. The system of claim 13, wherein reconfiguring the garbage collection configuration further includes allocating additional processing resources for performing garbage collection based on one or more periods of time that write activity is predicted to be below a threshold rate, and wherein initiating garbage collection comprises initiating garbage collection during the one or more periods of time.

15. The system of claim 13,
wherein the workload data for the one or more applications indicates a level of write demand for writing data to the storage system, and
wherein reconfiguring the garbage collection configuration for the storage system comprises modifying the one or more thresholds based on the indicated level of write demand for writing data to the storage system.

16. The system of claim 13, further comprising instructions being executable by the one or more processors to:
determine the current state relative to the first storage threshold and the second storage threshold;
when the current state of storage on the storage system is between the first storage threshold and the second storage threshold, initiate garbage collection on the storage system further based on the workload data indicating that a current level of write activity is below a threshold rate; and
when the current state of storage on the storage system is below both the first storage threshold and the second storage threshold, initiate garbage collection on the storage system independent of the workload data indicating that the current level of write activity is above the threshold rate.

17. A method, comprising:
receiving, from an application on a computing device, workload data including information associated with write activity of the application with respect to a solid-state drive (SSD) storage on the computing device;
reconfiguring a garbage collection configuration for the SSD storage based on the workload data by modifying one or more storage thresholds corresponding to levels of available write space on the SSD storage, the one or more storage thresholds being associated with initiating garbage collection on the SSD storage; and
initiating garbage collection on the SSD storage in accordance with the reconfigured garbage collection configuration based on a comparison of the modified one or more storage thresholds and a current state of storage on the SSD storage.

18. The method of claim 17, wherein reconfiguring the garbage collection configuration further includes allocating additional processing resources for performing garbage collection based on one or more periods of time that write activity is predicted to be below a threshold rate, and wherein initiating garbage collection comprises initiating garbage collection during the one or more periods of time.

19. The method of claim 17,
wherein the workload data for the application indicates a level of write demand for writing data to the SSD storage, and
wherein reconfiguring the garbage collection configuration for the SSD storage comprises modifying the one or more thresholds based on the indicated level of write demand for writing data to the SSD storage.

20. The method of claim 17, further comprising:
determining the current state relative to the first storage threshold and the second storage threshold;
when the current state of storage on the storage system is between the first storage threshold and the second storage threshold, initiating garbage collection on the SSD storage further based on the workload data indicating that a current level of write activity is below a threshold rate; and
when the current state of storage on the SSD storage is below both the first storage threshold and the second storage threshold, initiate garbage collection on the SSD storage independent of the workload data indicating that the current level of write activity is above the threshold rate.
